(19) United States
(12) Patent Application Publication
(10) Pub. No.: US 2003/0165634 A1
(43) Pub. Date: Sep. 4, 2003

(54) Method for eliminating high voltage arcing for DC planar push-pull poling of polymer modulators

(76) Inventors: Lawrence Joseph Dries, Sunnyvale Santa Clara, CA (US); Dexter George Girton, Santa Clara, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/119,314

(22) Filed: Apr. 10, 2002

Related U.S. Application Data
(60) Provisional application No. 60/282,477, filed on Apr. 10, 2001.

(51) Int. Cl. B05D 3/00

(52) U.S. Cl. 427/551

(57) ABSTRACT

A process is given to protect polymer modulators during push-pull poling employing high voltages to the electrodes is given where a thin layer of dielectric material is applied to the electrodes prior to poling, applying the direct current high voltage, and removing the dielectric after completion of poling.

This application is based on Provisional Application 60/282,477 filed Apr. 10, 2001.

### FIELD OF THE INVENTION

The present invention relates to push-pull poling. More particularly, the present invention relates to enhancement of voltage sensitivity of a polymer modulator by performing push-pull poling.

The present invention relates to polymer modulator fabrication, and more particularly, the invention pertains to methods of improving the process of producing modulator systems. Specifically this invention relates to a process and technique for push-pull poling of polymer modulators. More specifically, this invention relates to a method for eliminating high voltage arcing for DC planar push-pull poling of polymer modulators.

### BACKGROUND OF THE INVENTION

There are several methods used in fabrication of polymers for use in electro-optic devices.

### DESCRIPTION OF THE RELATED ART

One known method of push-pull poling involves burying high voltage poling electrodes at the bottom of a polymer device and a ground plane on the surface. This method would introduce undesirable optical effects in the waveguides due to distortion of the planar profile of the current device design. It would also cause significant difficulties in the fabrication process.

Other known poling methods, such as corona poling, are unsuitable for push-pull poling of polymer modulators.

### SUMMARY OF THE INVENTION

The present invention allows alignment of chromophore in the core layer to be aligned by push-pull poling while minimizing the likelihood of high voltage arcing. In a preferred embodiment of the present invention, this arcing is eliminated by applying a thin layer of insulating dielectric material on top of the electrodes before poling.

### DESCRIPTION OF THE DRAWINGS

The present invention is described with reference to the accompanying drawings, wherein:

FIG. 1 shows a preferred embodiment of the present invention.

### DETAILED DESCRIPTION OF THE INVENTION

Push-pull poling of polymer modulators can be accomplished by applying DC high voltage of opposite polarity to the electrodes over the two arms of the modulator during the chromophore alignment process or poling. There is a substantial problem of high voltage arcing between the two electrodes when the potential difference of up to 2000 volts is applied during the poling process because these two electrodes are typically separated by only 40 microns and because the poling electrodes in the current device design are on the top surface of the device, which is exposed to the ambient environment.

In a preferred embodiment of the present invention, this arcing is eliminated by applying a thin layer of insulating dielectric material on tope of the electrodes before poling. A preferred insulating dielectric material is an epoxy such as, for example, Norland 61 optical epoxy. This insulating dielectric is then removed from the device after completion of the poling step. This allows a potential difference of over 2000 volts to be applied in the poling process at high temperature.

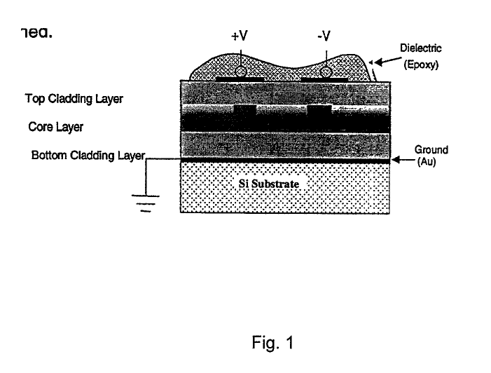

FIG. 1 shows a preferred embodiment of the present invention. High voltage of opposite polarity (typically +1000 volts and −1000 volts) is applied to the two upper electrodes as shown while the device is held at high temperature. This allows the chromophore in the core layer to be aligned. After the poling process is complete, the insulating dielectric layer can be removed and the device operated normally.

This process allows push-pull poling that doubles the voltage sensitivity of the polymer modulators.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments.

What is claimed is:

1. A method of protecting polymer modulators from electrical arcing by comprising applying a thin layer of insulating dielectric material over the surface before poling.

2. The method of claim 1 where the dielectric material is an epoxy.

3. A method of protecting polymer modulators during push-pull poling employing high voltages to the electrodes comprising applying a thin layer of dielectric material to the electrodes prior to poling, applying the direct current high voltage, and removing the dielectric after completion of poling.

4. The method of claim 3 wherein the dielectric material is an epoxy material.
